(19) United States
(12) Patent Application Publication
(10) Pub. No.: US 2012/0002258 A1
(43) Pub. Date: Jan. 5, 2012

(54) OPTICAL ELEMENT

(75) Inventor: Yoshihisa MASUDA, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 13/171,406

(22) Filed: Jun. 28, 2011

Related U.S. Application Data
(60) Provisional application No. 61/360,435, filed on Jun. 30, 2010.

(51) Int. Cl. G02B 26/10

(52) U.S. Cl. 359/197.1

(57) ABSTRACT

An optical element has a plurality of first machining portions and a plurality of second machining portions. The plurality of first machining portions is aligned in a first direction and the first machining portions each have a convex shape. The plurality of second machining portions is aligned in the first direction along the plurality of first machining portions and the second machining portions each have a convex shape. Ends of the second machining portions in the first direction are adjacent to the corresponding first machining portions, in a second direction perpendicular to the first direction. The ends of the second machining portions in the first direction are disposed further from end of the corresponding first machining portions in the first direction, than the length of the first machining portions or the second machining portions in the second direction.

### CROSS-REFERENCE TO RELATED APPLICATION

This application is based upon and claims the benefit of priority from: U.S. provisional application 61/360435, filed on Jun. 30, 2010; the entire contents all of which are incorporated herein by reference.

### FIELD

Embodiments described herein relate generally to an optical element.

### BACKGROUND

The surfaces of lenses are formed by using a mold. A plurality of machining marks remains on the surfaces of the lenses. When the machining marks remain, unintended optical properties may be caused in the lenses.

### DESCRIPTION OF THE DRAWINGS

FIG. 1 is a cross-sectional view of an image forming apparatus.

FIG. 2 is a front view of a portion of a lens.

FIG. 3 is a cross-sectional view taken along the line A1-A1 of FIG. 2.

FIG. 4 is a cross-sectional view taken along the line A2-A2 of FIG. 2.

FIG. 5 is a cross-sectional view taken along the line B1-B1 of FIG. 2.

FIG. 6 is a cross-sectional view taken along the line B2-B2 of FIG. 2.

FIG. 7 is a diagram illustration positional relationship between the edge of a first machining portion and the edge of a second machining portion.

### DETAILED DESCRIPTION

An optical element of an embodiment has a plurality of first machining portions and a plurality of second machining portions. The plurality of first machining portions is aligned in a first direction and the first machining portions each have a convex shape. The plurality of second machining portions is aligned in the first direction along the plurality of first machining portions and the second machining portions each have a convex shape . Ends of the second machining portions in the first direction are adjacent to the corresponding first machining portions, in a second direction perpendicular to the first direction. The ends of the second machining portions in the first direction are disposed further from end of the corresponding first machining portions in the first direction, than the length of the first machining portions or the second machining portions in the second direction.

### First Embodiment

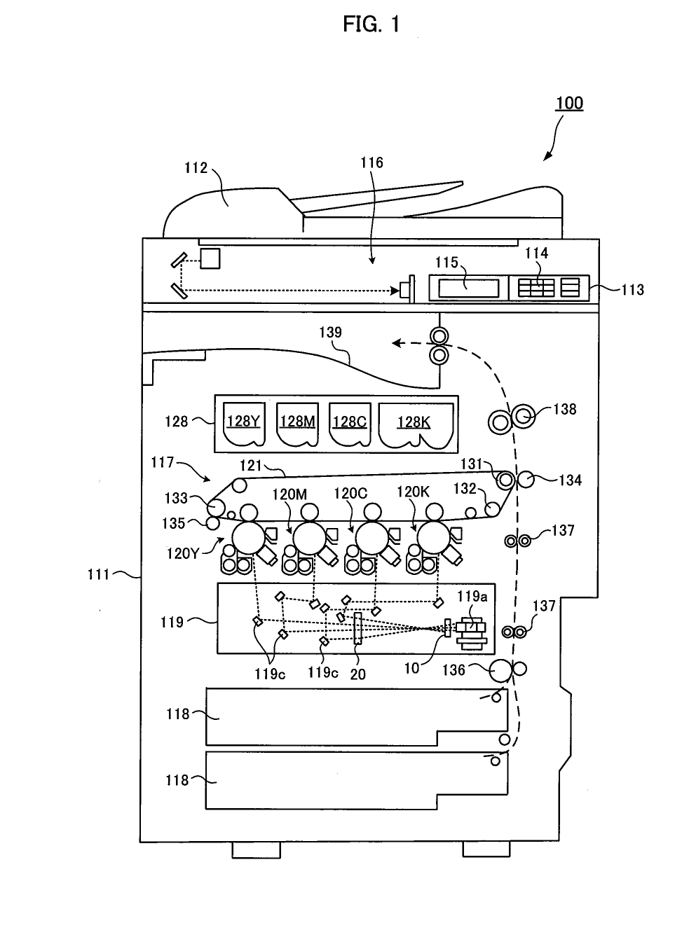

FIG. 1 is a view showing the internal configuration of an image forming apparatus according to a first embodiment. A platen is disposed at the upper portion of a main body 111 of an image forming apparatus 100 and an ADF (Auto Document Feeder) 112 is disposed on the platen. The ADF 112 feeds documents to the platen. An operation panel 113 is disposed at the upper portion of the main body 111. The operation panel 113 includes an operation part 114 including various keys and a display part 115.

A scanner 116 generates image data by reading the documents placed on the platen. A printer unit 117 forms an image corresponding to input image data on a piece of paper. As the image data, there is image data generated by the scanner 116 or image data transmitted from an external device, such as a PC (Personal Computer) to the image forming apparatus 100.

The printer unit 117 includes image forming units 120Y, 120M, 120C, and 120K for yellow Y, magenta M, cyan C, and black K. The image forming units 120Y to 120K are disposed along an intermediate transfer belt 121.

The image forming units 120Y to 120K each include a photoconductive drum. A charger, a developing device, a primary transfer roller, a cleaner, and blades are disposed around the photoconductive drums.

A laser beam that is irradiated from an exposure device 119, corresponding to yellow reaches the exposure position of the photoconductive drum of the image forming unit 120Y. An electrostatic latent image is formed on the surface of the photoconductive drum by the laser beam. The charger charges the surface of the photoconductive drum. The developing device supplies toner to the photoconductive drum. The cleaner removes the toner remaining on the surface of the photoconductive drum, using the blades.

A toner cartridge 128 is disposed above the image forming units 120Y to 120K and the toner cartridge 128 supplies toner to the developing devices of the image forming units 120Y to 120K. There are toner cartridges 128Y, 128M, 128C, and 128K that accommodate yellow Y, magenta M, cyan C, and black K toners, as the toner cartridge 128.

The intermediate transfer belt 121 is held around a driving roller 131 and driven rollers 132 and 133. The photoconductive drums of the image forming units 120Y to 120K are in contact with the intermediate transfer belt 121. In the image forming unit 120Y, the primary transfer roller transfers the toner image of the photoconductive drum to the intermediate transfer belt 121 by applying primary transfer voltage to the intermediate transfer belt 121. Similarly, in the image forming units 120M to 120K, the toner images of the photoconductive drums are transferred to the intermediate transfer belt 121 by the primary transfer roller.

A secondary transfer roller 134 is disposed opposite to the driving roller 131. When a piece of paper passes through between the driving roller 131 and the secondary transfer roller 134, the secondary transfer roller 134 transfers the toner image of the intermediate transfer belt 121 onto the paper by applying secondary transfer voltage to the intermediate transfer belt 121. A belt cleaner 135 is disposed opposite to the driven roller 133.

The exposure device 119 scans by irradiating a laser beam according to image information to the photoconductive drums of the image forming units 120Y to 120K. Electrostatic latent images corresponding to the colors (Y, M, C, and K) are formed on the photoconductive drums of the image forming units 120Y to 120K by the laser beam.

A polygon mirror 119a bias scans the laser beam irradiated from a semiconductor laser. An fθ lens 10 and an fθ lens 20 correct distortion of the laser beam and the like biased by the polygon mirror 119a. The laser beam passing through the fθ lens 10 reflects from a mirror 119c and reaches the photoconductive drums of the image forming units 120Y to 120K.

The main body 111 accommodates a plurality of paper cassettes 118. The paper cassettes 118 accommodate a plurality of pieces of paper. A separating roller 136 takes out the paper accommodated in the paper cassettes 118. A feeding roller 137 feeds the paper from the paper cassettes 118 to the secondary transfer roller 134.

A fixing device 138 fixes an image onto a piece of paper by heating the paper fed from the secondary transfer roller 134. The paper passing through the fixing device 138 is discharged to a tray 139.

The structure of the fθ lens 10 is described in detail. The description of the fθ lens 20 is omitted since the fθ lens 20 is similar to the fθ lens 10.

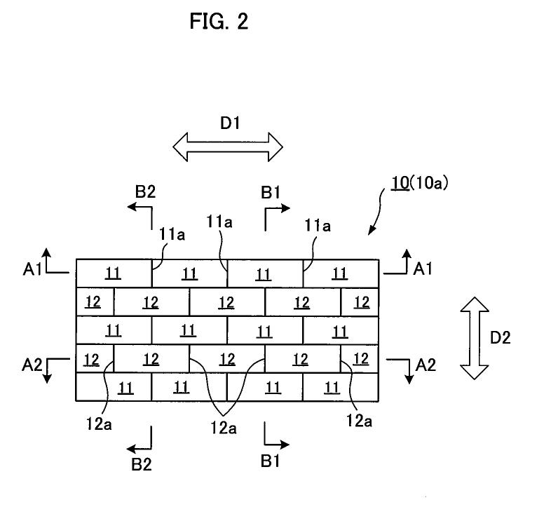

FIG. 2 is a front view showing a portion of an incident surface 10a of the lens 10. The incident surface 10a has a plurality of first machining portions 11 and a plurality of second machining portions 12.

The first machining portions 11 and the second machining portions 12 can be formed by using a mold. In detail, the first machining portions 11 and the second machining portions 12 can be formed on the lens 10 by injection molding or by softening a preform lens at high temperature and pressing the softened preform lens with a mold.

The first machining portions 11 and the second machining portions 12 are machining marks that are formed on the surface (incident surface 10a) of the lens 10, in forming using the mold. The lens 10 may be made of glass or plastic.

The plurality of first machining portions 11 are aligned in the transverse direction D1 (corresponding to the first direction). The plurality of second machining portions 12 are aligned in the transverse direction D1.

The line of the first machining portions 11 aligned in the transverse direction D1 and the line of the second machining portions 12 aligned in the transverse direction D1 are alternately aligned in the longitudinal direction D2 (corresponding to the second direction). The transverse direction D1 and the longitudinal direction D2 are perpendicular to each other. The edge of the second machining portion is adjacent to the corresponding first machining portion 11 in the longitudinal direction.

The shape of the incident surface 10a is appropriately set on the basis of the optical properties (optical power) of the lens 10. The incident surface 10a, for example, may be a convex surface, a concave surface, or an adjustable surface. When the shape of the incident surface 10a is determined, the first machining portions 11 and the second machining portions 12 are formed in accordance with the shape of the incident surface 10a. That is, the incident surface 10a is implemented by the plurality of first machining portions 11 and the plurality of second machining portions 12.

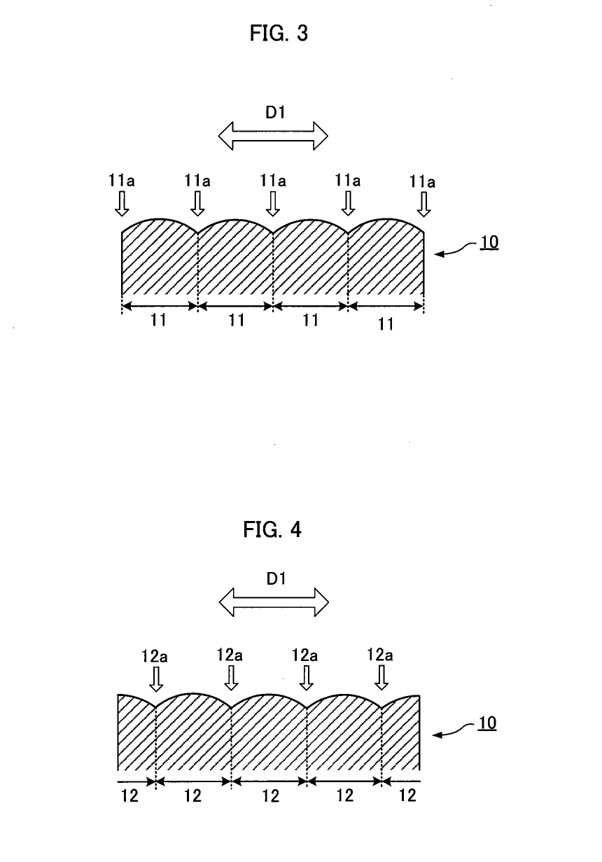

FIG. 3 is a cross-sectional view taken along the line A1-A1 of FIG. 2. The A1-A1 cross-section is a cross-section when the lens 10 is cut with a plane perpendicular to the longitudinal direction D2. As shown in FIG. 3, the first machining portions 11 have convex shapes on the A1-A-1 cross section (surface including the transverse direction D1).

FIG. 4 is a cross-sectional view taken along the line A2-A2 in FIG. 2. The A2-A2 cross-section is a cross-section when the lens 10 is cut with a plane perpendicular to the longitudinal direction D2. As shown in FIG. 4, the second machining portions 12 have convex shapes on the A2-A2 cross section (surface including the transverse direction D1).

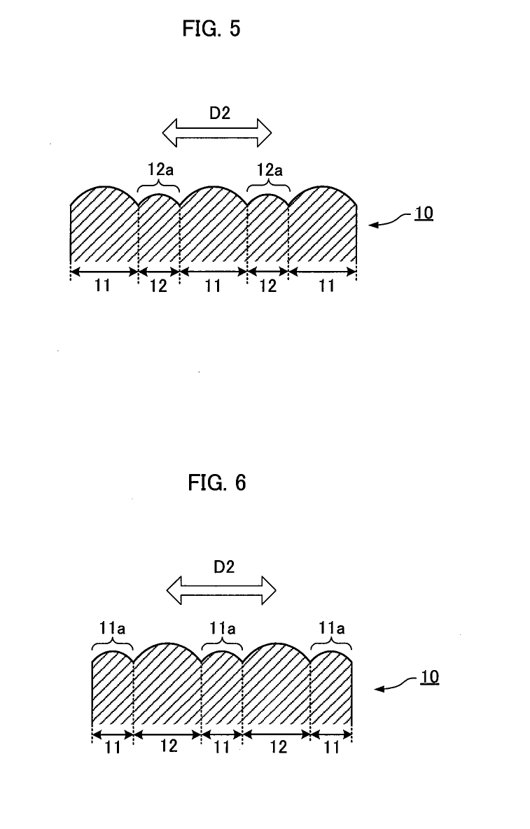

FIG. 5 is a cross-sectional view taken along the line B1-B1 of FIG. 2. The B1-B1 cross-section is a cross-section when the lens 10 is cut with a plane perpendicular to the transverse direction D1. As shown in FIG. 5, the first machining portions 12 have convex shapes on the B1-B1 cross section (surface including the longitudinal direction D2).

FIG. 6 is a cross-sectional view taken along the line B2-B2 in FIG. 2. The B2-B2 cross-section is a cross-section when the lens 10 is cut with a plane perpendicular to the transverse direction D1. As shown in FIG. 6, the second machining portions 12 have convex shapes on the B2-B2 cross section (surface including the longitudinal direction D2).

In the configuration shown in FIG. 2, three lines of the first machining portions 11 are arranged and two lines of the second machining portions 12 are arranged. The line of the first machining portions 11 may be two lines while the second machining portions 12 may be three lines. The lines of the first machining portions 11 or the lines of the second machining portions 12 depend on the size of the first machining portions 11 or the second machining portions and the size of the incident surface 10a.

In the first machining portions 11 included in different lines, edges 11a of the first machining portions 11 are on a straight line extending in the longitudinal direction D2. The edges 11a included in different lines of the first machining portions 11 may not be on the straight line extending in the longitudinal direction D2, or may deviate in the transverse direction D1.

In the second machining portions 12 included in different lines, edges 12a of the second machining portions 12 are on a straight line extending in the longitudinal direction D2. The edges 12a included in different lines of the second machining portions 12 may not be on the straight line extending in the longitudinal direction D2, or may deviate in the transverse direction D1.

An exit surface of the lens 10, similar to the incident surface 10a, may be formed by the first machining portions 11 and the second machining portions 12. The shape of the exit surface is appropriately set on the basis of the optical properties of the lens 10.

The first machining portions 11 and the second machining portions 12 have the same size. In detail, the length of the first machining portions 11 in the transverse direction D1 is the same as the length of the second machining portions 12 in the transverse direction D1. The length of the first machining portions 11 in the longitudinal direction D2 is the same as the length of the second machining portions 12 in the longitudinal direction D2.

The length of the first machining portions 11 in the transverse direction D1 may be different from the length of the second machining portions 12 in the transverse direction D1. The length of the first machining portions 11 in the longitudinal direction D2 maybe different from the length of the second machining portions 12 in the longitudinal direction D2.

The edges 12a of the second machining portions 12 deviate from the edges 11a of the first machining portions 11 in the transverse direction D1. The edges 11a protrude, as shown in FIG. 3, at the interface of two first machining portions 11 adjacent to each other in the transverse direction D1. The edges 12a protrude, as shown in FIG. 4, at the interface of two second machining portions 12 adjacent to each other in the transverse direction D1.

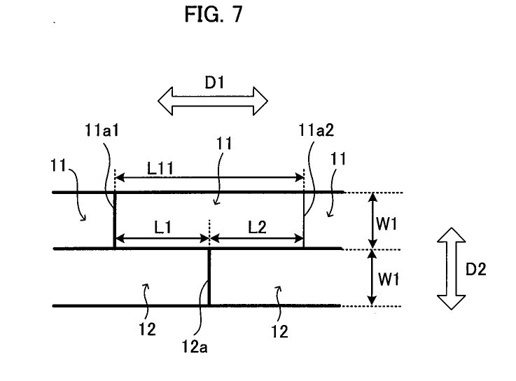

FIG. 7 is a view illustrating positional relationship between the edges 11a and the edges 12a.

In FIG. 7, a first edge 11a1 and a second edge 11a2 are at both ends of the first machining portion 11 in the transverse direction D1. The first edge 11a1 and the second edges 11a2 are the edges 11a of the first machining portion 11.

As shown in FIG. 7, the edges 12a of the second machining portions 12 are in parallel with the corresponding first machining portions 11 in the longitudinal direction D2. In the transverse direction D1, the edges 12a of the second machining portions 12 are positioned between the first edge 11a1 and the second edge 11a2 of the corresponding first machining portion 11.

In the transverse direction D1, a gap between the first edge 11a1 of the first machining portion 11 and the edge 12a of the second machining portion 12 is L1. In the transverse direction D1, a gap between the second edge 11a2 of the first machining portion 11 and the edge 12a of the second machining portion 12 is L2.

The gap L1 and the gap L2 are the same as each other. In other words, the edge 12a of the second machining portion 12 is positioned at the center between the first edge 11a1 and the second edge 11a2 in the transverse direction D1.

The gap L1 and the gap L2 may be different from each other. When the gaps L1 and L2 are different from each other, the edge 12a approaches one of the first edge 11a1 and the second edge 11a2 in the transverse direction D1.

The sum of the gap L1 and the gap L2 is a length L11 of the first machining portion 11 in the transverse direction D1. The gap L1 is larger than a length W1 of the first machining portion 11 (or the second machining portion 12) in the longitudinal direction D2. The gap L2 is larger than the length W1 of the first machining portion 11 (or the second machining portion 12).

The gap L1 may be ⅓ or more of the length L11. When the gap L1 is ⅓ or more of the length L1, the gap L2 is the length obtained by subtracting the gap L1 from the length L11.

Meanwhile, the gap L2 may be ⅓ or more of the length L11. When the gap L2 is ⅓ or more of the length L11, the gap L1 is the length obtained by subtracting the gap L2 from the length L11.

According to the embodiment, it is possible to prevent unintended optical properties from being generated in the lens 10, by the edge 11a of the first machining portion 11 or the edge 12a of the second machining portion 12. When the edges 11a and 12a are aligned in the longitudinal direction D2, a line of the edges 11a and 12a is formed on the incident surface 10a. Unintended optical properties are generated on the incident surface 10a by substantially aligning the edges 11a and 12a on line.

In the embodiment, since the edges 11a and 12a deviate from each other in the transverse direction D1, it is possible to prevent the edges 11a and 12a from being aligned on line in the longitudinal direction D2.

It is possible to prevent unintended optical properties from being generated in the lens 10 by removing the edges 11a and 12a, such as through grinding and the like. However, when the edges 11a and 12a are ground, grinding is added to the manufacturing process of the lens 10. In the embodiment, it is possible to prevent unintended optical properties from being generated in the lens 10, without performing grinding or the like.

In the embodiment, although the lens 10 is used as the fθ lens, lenses having other functions may be applied. The lens 10 may be used as the lens disposed in the image forming apparatus 100. The lens 10 may be used for lenses that are used in devices other than the image forming apparatus 100.

In the embodiment, although the fθ lens 10 has the first machining portions 11 and the second machining portions 12, other optical elements may have the first machining portions 11 and the second machining portions 12. There is a mirror reflecting light as the optical element, in addition to lenses that transmit light.

The first machining portions or the second machining portions maybe formed on the reflective surface of the mirror. In detail, as in the lens 10, the reflective surface of the mirror may be formed by using a mold. A reflective layer may be formed on the surface of the mirror. For example, the reflective layer may be formed by applying reflective paint on the surface of the mirror. The reflective layer is formed along the first machining portions and the second machining portions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An optical element comprising:
a plurality of first machining portions that is aligned in a first direction and have convex shapes; and
a plurality of second machining portions that is aligned along the plurality of first machining portions in the first direction and have convex shapes, end of the second machining portion in the first direction being adjacent to the corresponding first machining portion in a second direction perpendicular to the first direction and disposed further from end of the corresponding first machining portion in the first direction, than the length of the first machining portion or the second machining portion in the second direction.

2. The optical element of claim 1,
wherein the lengths of the first machining portion and the second machining portion are the same as each other in the first direction.

3. The optical element of claim 1,
wherein the lengths of the first machining portion and the second machining portion are the same as each other in the second direction.

4. The optical element of claim 1,
wherein the end of the second machining portion is positioned at the same distance from both ends of the corresponding first machining portion in the first direction.

5. The optical element of claim 1,
wherein the end of the second machining portion is positioned at a distance of ⅓ or more of the length of the first machining portion in the first direction, from one end of the corresponding first machining portion.

6. The optical element of claim 1,
wherein line of the plurality of first machining portions and line of the plurality of second machining portions are alternately disposed in the second direction.

7. The optical element of claim 1,
wherein the sum of lines of the plurality of first machining portions and lines of the plurality of second machining portions is at least five or more.

8. The optical element of claim 1,
wherein lines of the plurality of first machining portions are arranged in plurality in the second direction, and
the ends of the first machining portions are on a straight line extending in the second direction.

9. The optical element of claim 1,
wherein lines of the plurality of second machining portions are arranged in plurality in the second direction, and
the ends of the second machining portions are on a straight line extending in the second direction.

10. The optical element of claim 1,
wherein the first machining portions and the second machining portions are made of glass or plastic.

11. The optical element of claim 1,
wherein the plurality of first machining portions and the plurality of second machining portions make an adjustable surface.

12. The optical element of claim 1,
wherein the plurality of first machining portions and the plurality of second machining portions make a concave surface.

13. The optical element of claim 1,
wherein the plurality of first machining portions and the plurality of second machining portions make a convex surface.

14. The optical element of claim 1,
wherein the first machining portions and the second machining portions transmit light.

15. The optical element of claim 1,
wherein the first machining portions and the second machining portions are formed on an incident surface for light.

16. The optical element of claim 1,
wherein the first machining portions and the second machining portions are formed on an exit surface for light.

17. The optical element of claim 1,
wherein the optical element is an fθ lens.

18. The optical element of claim 1,
wherein the first machining portions and the second machining portions reflect light.

19. The optical element of claim 1, further comprising
a reflective layer that reflects light and covers at least a part of the first machining portions and the second machining portions.
